(19) United States
(12) Patent Application Publication
(10) Pub. No.: US 2026/0161704 A1
(43) Pub. Date: Jun. 11, 2026

(54) MUSIC PLAYLIST CREATION SYSTEM

(71) Applicant: Chris Davis, Rigby, ID (US)

(72) Inventor: Chris Davis, Rigby, ID (US)

(21) Appl. No.: 19/414,586

(22) Filed: Dec. 10, 2025

Related U.S. Application Data
(60) Provisional application No. 63/730,542, filed on Dec. 11, 2024.

(51) Int. Cl. G06F 16/638; G06F 3/04817

(52) U.S. Cl. CPC G06F 16/639; G06F 3/04817

(57) ABSTRACT

A music playlist creation system includes a smart device, a first application (e.g., mobile or software), and a second application (e.g., mobile or software), both applications may be on the smart device. The system allows users to survey music so as to obtain the most customizable music playlists possible for clients. More particularly, the system allows clients to participate in playlist creation for events, thereby the playlist reflects the preferences of the client.

### CROSS-REFERENCE TO RELATED APPLICATIONS

This application claims the benefit of U.S. Provisional Application Ser. No. 63/730,542, filed on Dec. 11, 2024, which is incorporated herein by reference.

### TECHNICAL FIELD

The present disclosure relates to a music playlist system. More particularly, the present disclosure relates to a customizable music playlist system that is generated via client ratings and comparison engines.

### BACKGROUND

Music is an important part of life for many individuals and has been on earth since man first walked its grounds. Music is and will continue to be central to cultures, weddings, birthdays, and many other events. To provide music for these types of events, some may use live bands and others may suggest playlists of music that they enjoy for a disc jockey. While many individuals attempt to create their own playlists for the disc jockey, countless music services do not allow playlists that are fully customizable or, at least, not easily customizable based on a users'preferences.

This creates many issues for disc jockeys that are trying to identify clients'musical preferences, meaning, for example, the disc jockey may have to have additional, unnecessary discussions with the clients to determine genres, artists, and songs that the clients want. Without these additional meetings, a disc jockey may not be able to generate playlists that the clients want for numerous reasons, such as lacking knowledge about the songs, genres, and/or artists that the clients enjoy.

Accordingly, there is a need for a system that allows users to generate their clients'musical preferences based on surveying. The present invention seeks to solve these and other problems.

### SUMMARY OF EXAMPLE EMBODIMENTS

In one embodiment, a music playlist creation system comprises a smart device, a first application (e.g., mobile or software), a second application (e.g., mobile or software), both applications may be on the smart device and a database. The first application may be a music streaming platform where users have accounts and can choose one or more primary playlists. The first application may be accessed via the second application. A first screen on the second application may allow the user to select one or more primary, or secondary, playlists that were previously created via the first application. The second application may also include a second screen that allows users (e.g., administrators and/or disc jockeys) to access tolerance levels (i.e., preferences) for each secondary playlist created. A third screen on the second application may be an events screen. The events screen allows the user to create an event (e.g., a client's wedding). A fourth screen (e.g., a web application) may be accessed via a link generated through the events screen. The fourth screen allows a client to input personal identifying information, such as his/her name. After this information is inputted, the client may access each song in the primary playlist that the user (e.g., disc jockey) chose in a fifth screen. A snippet of each song is played for the client. The client(s) can rate each song based on the song, artist, and genre. A sixth screen allows the user to generate a playlist based on the ratings received from the client. More specifically, the ratings received are compared to the secondary playlist selected by a second user (e.g., disc jockey) and based upon the thresholds set by the user, a tertiary, final playlist is generated and can be exported to the first application.

In one embodiment, a method of using the system includes a first user (e.g., an administrator). The first user then connects their first application account (e.g., Deezer® account) through the first application's application programming interface (“API”) to the second application and chooses one or more primary playlists to import to the second application. A second user (e.g., an administrator and/or disc jockey) is connected to the second application, where the second user chooses one or more secondary playlists, (the one or more primary playlists imported by the first user that stay the same of are changed) on the second application. The second user may manipulate the one or more primary playlists, meaning the second user may add the one or more primary playlists together, pick and choose songs from the playlist, or adjust by any other means the one or more primary playlists so as to create the one or more secondary playlists. The second user chooses their level of tolerance for each set of the one or more secondary playlists via one or more adjustable factors/criteria (i.e., rankings), such as song, artist, and genre, and the one or more adjustable factors are saved by the second user and factored into a tertiary, final playlist. The second user also determines how many total songs are in the final/tertiary, generated playlist in addition to the randomization, as described herein. This data set (i.e., one or more adjustable factors data) is then uploaded to the database (e.g., MongoDB).

As previously discussed, the second user may adjust each secondary playlist set to different thresholds or change the adjustable factors. The second user then adds the one or more secondary playlists from the second application. The second user creates an event and attaches the one or more secondary playlists, which stem from the one or more primary playlists imported by the first user from the first application to the second application, to the event. After the event is created, a link is generated for that event and can be sent to a third user (e.g., a client or other party). The third user may follow the link to a webpage where personal information is input and where the third user is shown each song in the one or more secondary playlists that the second user chose for them. A short snippet is played for the third user from the first application, or second application, and the third user(s) may rate each song based on various criteria, such as song, artist, and genre. Once all songs are rated, they are submitted back to the second user. The second user can view the results as an aggregate or see the individual ratings for each song. The second user then generates the final playlist based on the ratings.

### BRIEF DESCRIPTION OF THE DRAWINGS

FIG. 1 illustrates a smart device of a music playlist creation system;

FIG. 2 illustrates a first screen of a music playlist creation system;

FIG. 3 illustrates a search pop-up of a music playlist creation system;

FIG. 4 illustrates a second screen of a music playlist creation system;

FIG. 5 illustrates a third screen of a music playlist creation system;

FIG. 6 illustrates an event pop-up of a music playlist creation system;

FIG. 7 illustrates a fourth screen of a music playlist creation system;

FIG. 8 illustrates a fifth screen of a music playlist creation system;

FIG. 9 illustrates a sixth screen of a music playlist creation system;

FIG. 10 illustrates a generate-playlist pop-up screen of a music playlist creation system;

FIG. 11 illustrates a seventh screen of a music playlist creation system; and

FIG. 12 illustrates a diagram of a music playlist creation system.

### DETAILED DESCRIPTION OF EXAMPLE EMBODIMENTS

While embodiments of the present disclosure may be subject to various modifications and alternative forms, specific embodiments have been shown by way of example in the drawings and will be described in detail herein. However, the present disclosure is not intended to be limited to the particular features, forms, components, etc. disclosed. Rather, the present disclosure will cover all modifications, equivalents, and alternatives falling within the scope of the present disclosure.

Reference to the invention, the present disclosure, or the like are not intended to restrict or limit the invention, the present disclosure, or the like to exact features or steps of any one or more of the exemplary embodiments disclosed herein. References to “one embodiment,” “an embodiment,” “alternate embodiments,” “some embodiments,” and the like, may indicate that the embodiment(s) so described may include a particular feature, structure, or characteristic, but not every embodiment necessarily includes the particular feature, structure, or characteristic.

Any arrangements herein are meant to be illustrative and do not limit the invention's scope. Although specific terms are employed herein, they are used in a generic and descriptive sense only and not for purposes of limitation. Unless otherwise defined herein, such terms are intended to be given their ordinary meaning not inconsistent with that applicable in the relevant industry and without restriction to any specific embodiment hereinafter described. Certain terms are used herein, such as “comprising” and “including,” and similar terms are meant to be “open” and not “closed” terms.

It will be understood that the steps of any such processes or methods are not limited to being carried out in any particular sequence, arrangement, or with any particular graphics or interface. In fact, the steps of the disclosed processes or methods generally may be carried out in various, different sequences and arrangements while still being in the scope of the present invention.

Portions of the music playlist creation system may be implemented wholly in hardware, wholly in software or combining software and hardware implementation that may all generally be referred to herein as a “circuit,” “module,” “component,” or “system.” It will be understood that computer program code for carrying out operations for features of the music playlist creation system on a smart device may be written in any programming language, which may include, but is not limited to, Objective-C, C++, C 190 , VB. NET, Java, Python, “C” programming language, Visual Basic, Perl, COBOL 2002, PHP, ABAP, Python, PHP, HTML, AJAX, or Ruby and Groovy. The program code may operate any portion of the system.

Portions of the system are illustrated in flowcharts and/or block diagrams. These flowcharts and/or block diagrams depict computer and mobile application program products according to embodiments of the system described herein. It will be understood that each block of the flowchart illustrations and/or block diagrams, and combinations of blocks in the flowchart illustrations and/or block diagrams, can be implemented by computer or mobile application program instructions.

As previously described, there is a need for a system that allows users to generate their clients'musical preferences based on surveying. The present invention seeks to solve these and other problems.

Music is important to every culture and to a lot of individuals. Thus, it is found at many events, such as weddings, parties, sporting events, homes, and many other venues. In this modern world, access to music and different types of music is readily available. To provide customized music to these types of events, some will create playlists of the music that they enjoy. However, countless music services do not allow playlists that are fully customizable or, at least, not easily customizable based on a user's preferences. This creates many issues for disc jockeys that are trying to identify musical preferences of their clients. Further, a disc jockey may not be able to generate a playlist that the client wants for numerous reasons. These reasons may be that clients do not know the song, genre, and/or artist.

The system described herein comprises a smart device, a first application (e.g., mobile or software), a second application (e.g., mobile or software), both applications may be on the smart device and a database. The system allows users to survey music so as to obtain the most customizable playlist possible for clients. Furthermore, it will be appreciated that the system allows clients to participate in playlist creation for events, thereby the playlist reflects the preferences of the client.

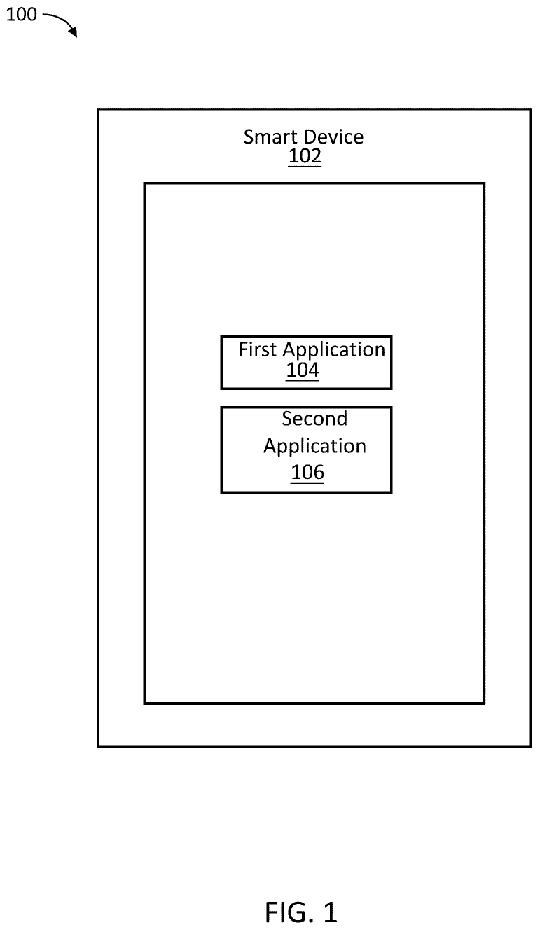

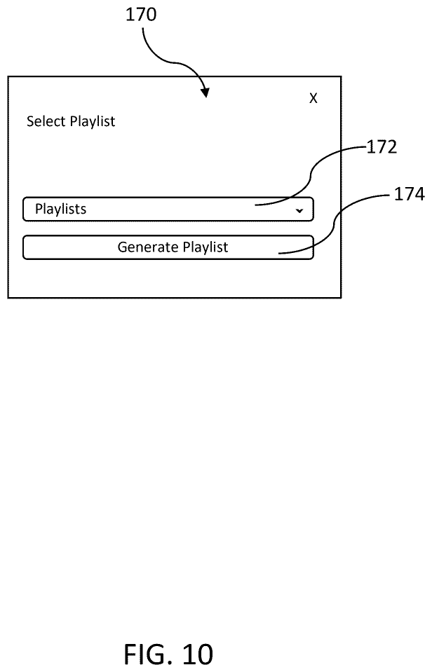

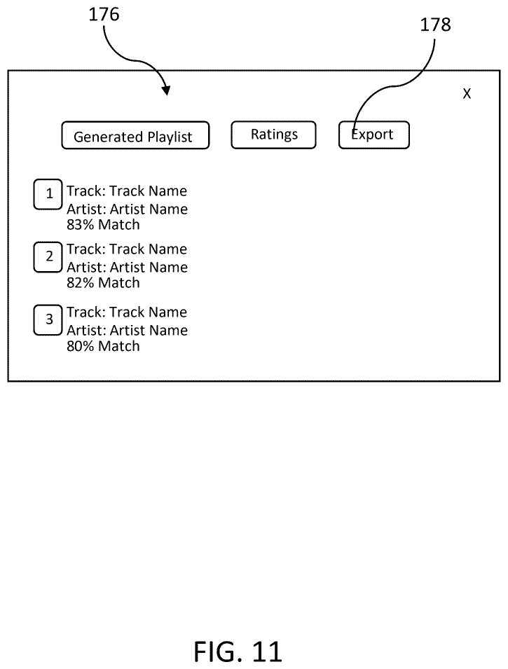

As shown in FIG. 1-11, in one embodiment, a music playlist creation system 100 (hereinafter referred to as the “system”) comprises a smart device 102, a first application (e.g., mobile or software) 104, and a second application 106 (e.g., mobile or software), both applications may be on the smart device 102 and a database. The smart device 102 may be a computer, smart phone, tablet, or any other computing device. The smart device 102 may comprise a display (e.g., a touch screen display), a processor, memory, and storage.

The first application 104 may be a music streaming platform where users have accounts and can choose one or more primary playlists to import to the second application 106. The first application 104 may be a music streaming platform, for example, Deezer®, Apple Music®, Tidal®, or any other streaming platform. The first application may be accessed via the second application 106, meaning one or more primary playlists on the first application may be accessed via the second application 106. In other embodiments, the one or more primary playlists may be accessed outside of the second application 106.

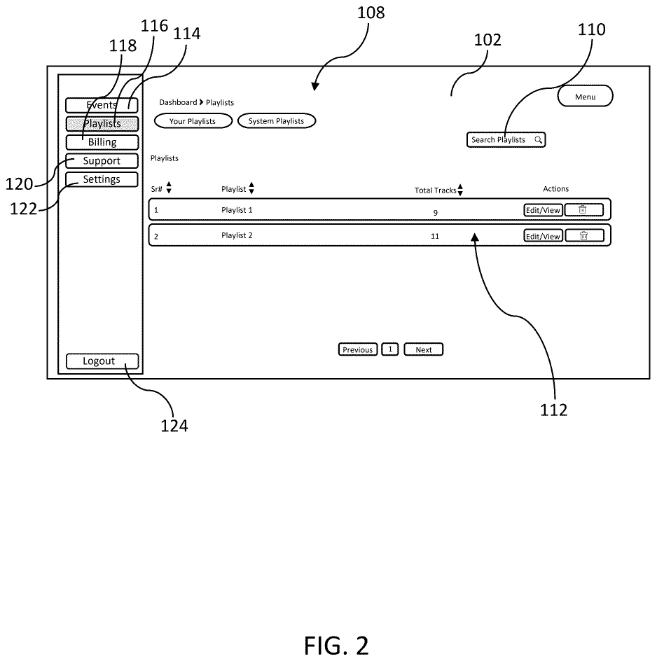

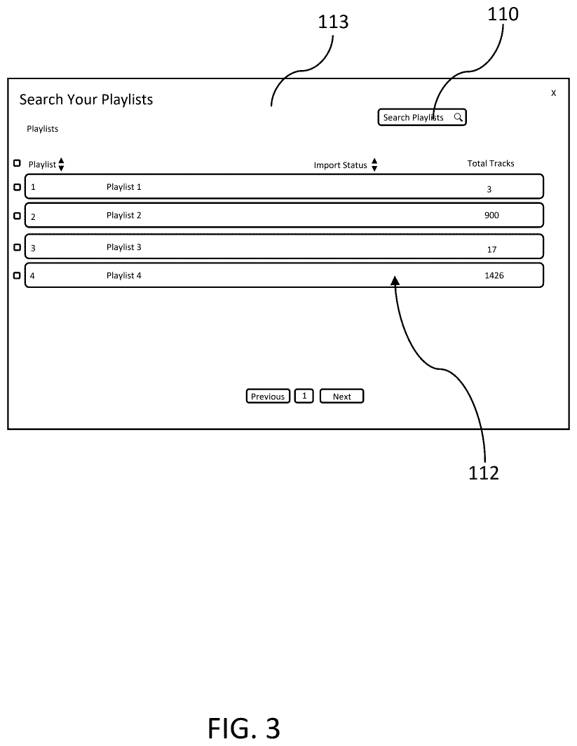

The second application 106 and/or website may be hosted by a hosting platform, for example, Heroku®, developed in node. js or any other hosting platform. The second application 106 may include multiple screens. In particular, as shown in FIGS. 2-3, a first screen 108 (i.e., when playlist button 116 is selected) on the second application 102 may allow the user to select one or more primary playlists that were previously created via the first application 104, which may be changed to second playlists. The first screen 108 may also include a search playlist box 110 and playlists 112. When the search playlist box 110 is selected as shown in FIG. 3, a user may view a search pop-up 113 where each playlist is located so as to check on the total tracks for each playlist. The playlists 112 that are selected are shown on the search pop-up and the first screen 108, where a user may view each selected playlist, its information, and edit the playlist or remove it. Referring to FIG. 2, other buttons on the first screen 108 may include an events button 114, a playlists button 116 and others, such as billing 118, support 120, settings 122, and logout 124.

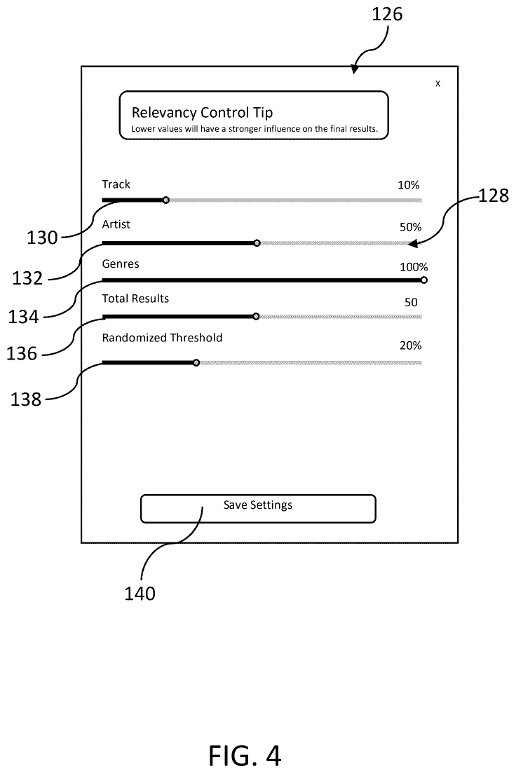

As shown in FIG. 4, the second application 106 may also include a second screen 126 that allows users to access tolerance levels (i.e., preferences) for each secondary playlist (playlists selected be users from the primary playlists) created, which, in some embodiments, may be playlists created by administrators or another party. In some embodiments, the playlist may be created by disc jockeys. The second screen 126 may include the following adjustable criteria 128 through a slide icon or by any other means known in the art: music track 130, artist 132, genres 134, total results 136, and randomized threshold 138. These adjustable criteria 128 allow the user to determine how much the song, artist, genres, etc. are factored into a tertiary, final playlist, as discussed below herein. It will be understood that while five adjustment levels are shown, there may be more or less than the five illustrated. Each of the adjustable criteria 128 may be placed on a scale from 0% to 100%, or another rating factor, which the lower one of the adjustable criteria 128 the more effect it has on the music playlist. In some embodiments, the higher the adjustable criteria 128 the more influence it has on the final, tertiary playlist. If the randomized threshold is set to 0%, then the results are the same every time. This is assuming that the ratings of the music, as will be discussed herein, are the same. If the randomized threshold is set at any other percent than 0%, the playlist will be randomized to that degree. All of the selected adjustable criteria 128 may be saved by selecting a save settings button 140.

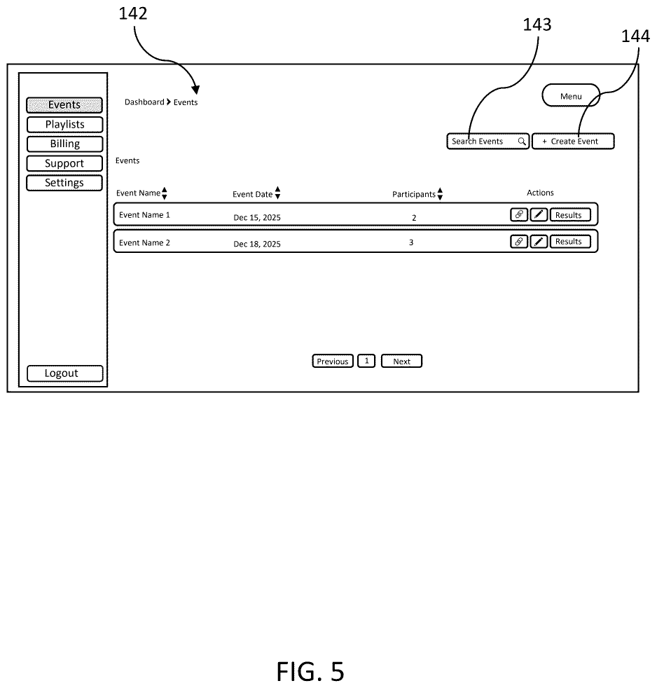

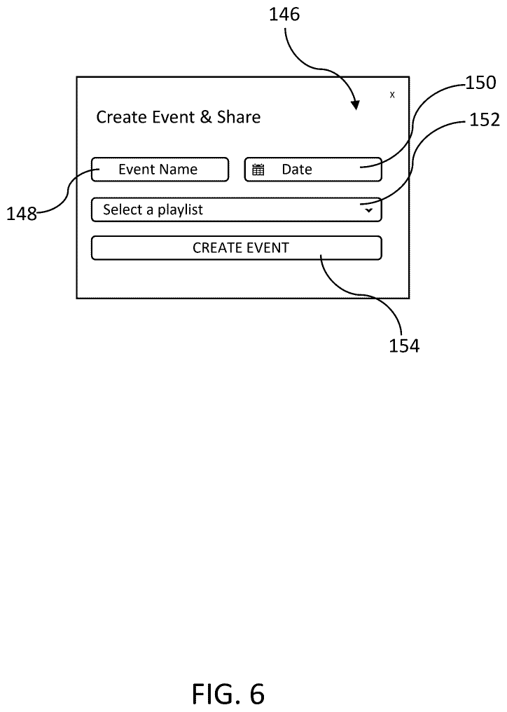

As shown in FIGS. 5-6, a third screen 142 on the second application 106 may be an events screen due to selection of the events button 114. The third screen 142 may include many of the same buttons on the first screen 108 but additionally include a search events button 143 and a create events button 144. Events may also be shown on the third screen 142, including event names, dates, participants, results of the playlist, etc. The events screen allows the user to create an event (e.g., a client's wedding or school dance) via an event pop-up screen 146 accessed by the create event button 144. The event pop-up screen 146 allows the user to input the name of the event into a first box 148, the date of the created event in a second box 150, and one of the preselected, imported primary playlists to the second application 106, now secondary playlists, may be attached to the created event by selecting the playlist via a third box/dropdown menu 152. After these have been selected, the event may be created via a create event button 154.

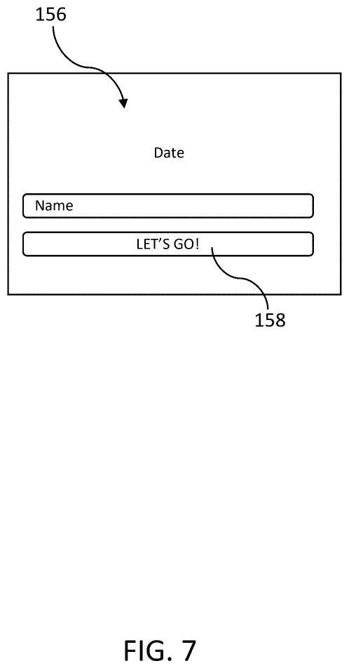

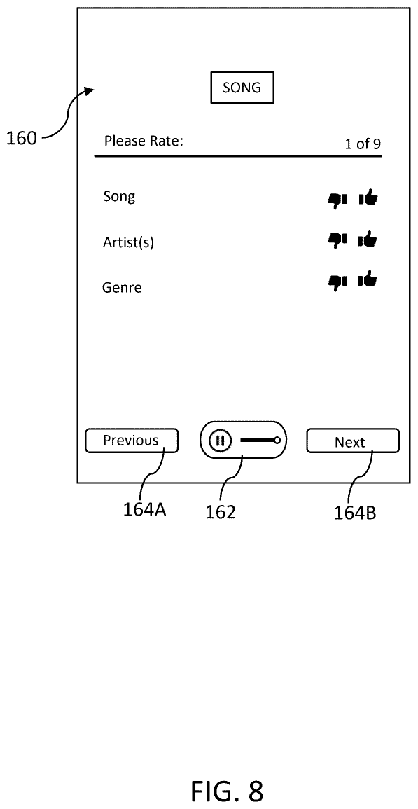

As shown in FIGS. 7-8, a fourth screen 156 (e.g., a web application) may be accessed via a link generated through the events screen. The fourth screen 156 allows a client to input personal identifying information, such as his/her name. After this information is inputted and submitted via a submit button 158, the client may access each song in the primary or secondary playlists that the user (e.g., disc jockey) chose in a fifth screen 160. A snippet of each song is played for the client via a play button 162. In some embodiments, a larger portion or the entirety of the song is played for the client. The fifth screen 160 also includes previous and next buttons 164A, 164B, respectively, that allows the client to switch between songs in the playlist. The client or clients, meaning multiple individuals can rate the primary or secodnary playlist for a given event, can rate each song based on the song, artist(s), and genre. The song, artist(s), and genre may each be rated by a like or dislike icon; however, in some embodiments, each of these may be rated on a number, percentage, or any other type of scale. Furthermore, while the factors for rating are illustrated as song, artist(s), and genre, these factors are not so limited and may include other factors, such as instruments used.

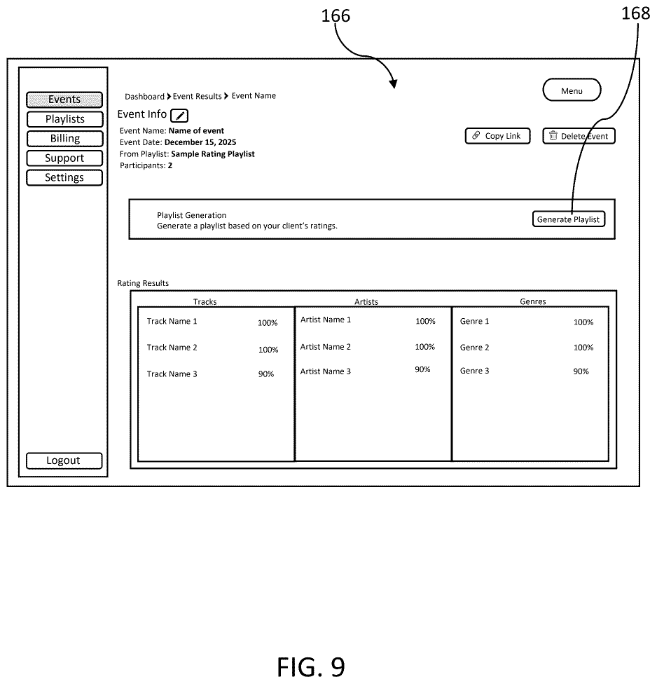

In FIGS. 9-11, a sixth screen 166, similar to the events screen, allows the user to generate a playlist based on the ratings received from the client by accessing and clicking on the generate playlist button 168. More specifically, the ratings received are compared to the secondary playlist selected by the user (e.g., administrator and/or DJ) via a generate-playlist pop-up screen 170. The generate-playlist pop-up screen 170 may include a playlist drop-down menu 172 and a generate playlist button 174. Based upon the thresholds, adjustable criteria, set by the user (e.g., administrator and/or DJ) and the ratings of the client, a tertiary playlist is generated and can be exported to the first application 104. The generated playlist may be accessible via a seventh screen 176 where the user can see the track, artist, and the match percentage based on the ratings. The user can then export the tertiary playlist by selecting an export button 178. While seven screens are discussed herein, it will be appreciated that more or less than seven screens may be utilized without departing from the present invention.

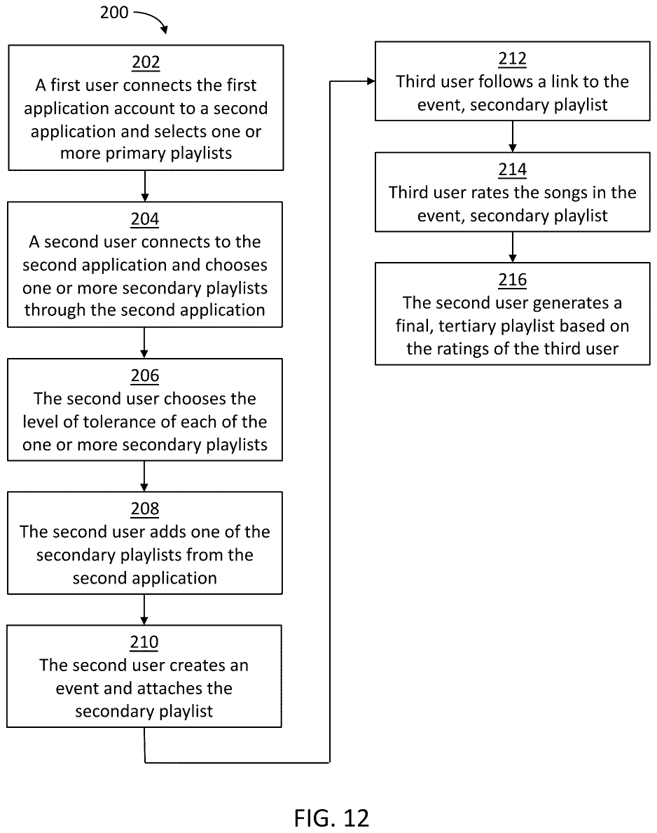

As shown in FIG. 12, a method 200 of using the system 100 includes a first user (e.g., an administrator) that connects their first application 104 account (e.g., Deezer® account) through the first application's 104 application programming interface (“API”) to the second application 106 and chooses one or more primary playlists to import to the second application 106, at step 202. At step 204, a second user (e.g., an administrator and/or disc jockey) (that signs up for access to the second application 106, where the second user is added to an email system, for example, Brevo®) is connected to the second application 106, where the second user chooses one or more secondary playlists, (the one or more primary playlists imported by the first user) on the second application 106. The second user may manipulate the one or more primary playlists, meaning the second user may add the one or more primary playlists together, pick and choose songs from the playlist, or adjust by any other means the one or more primary playlists so as to create the one or more secondary playlists. At step 206, the second user chooses their level of tolerance for each set of the one or more secondary playlists via one or more adjustable factors/criteria (i.e., rankings), such as song, artist, and genre, and the one or more adjustable factors are saved by the second user and factored into a tertiary, final playlist. The second user also determines how many total songs are in the final/tertiary, generated playlist in addition to the randomization. This data set (i.e., one or more adjustable factors data) is then uploaded to the database (e.g., MongoDB).

As previously discussed, the second user may adjust each secondary playlist set to different thresholds or change the adjustable factors. At step 208, the second user then adds the one or more secondary playlists from the second application 106. At step 210, the second user creates an event and attaches the one or more secondary playlists, which stem from the one or more primary playlists imported by the first user from the first application 104 to the second application 106, to the event. After the event is created, a link is generated for that event and can be sent to a third user (e.g., a client or other party). At step 212, the third user may follow the link to a webpage where personal information is input and where the third user is shown each song in the one or more secondary playlists that the second user chose for them. At step, 214, a short snippet is played for the third user from the first application, or second application, and the third user(s) may rate each song based on various criteria, such as song, artist, and genre. Once all songs are rated, they are submitted back to the second user. The second user can view the results as an aggregate or see the individual ratings for each song. At step 216, the second user then generates the final playlist based on the ratings. This final playlist is produced by (1) the second user choosing the playlist type to be generated, which is based on the one or more secondary playlists selected by the second user; (2) the ratings from the one or more secondary playlists being compared to the selected, playlist, which occurs via a data platform, such as Upstash; and (3) the thresholds set by the first user and/or second user that allow the final playlist to be generated and shown to the first user and/or second user. The final playlist may be exported to the first application, or, potentially, other locations.

It will be appreciated that the first, second, and third users may change positions as described above, meaning, for example, that the first user, administrator, may have input in place of the second user, disc jockey.

It will be understood that while various embodiments have been disclosed herein, other embodiments are contemplated. Further, certain embodiments of the present disclosure may include, incorporate, or otherwise comprise properties or features described in other embodiments. Consequently, various features of certain embodiments can be compatible with, combined with, included in, and/or incorporated into other embodiments of the present disclosure. Therefore, disclosure of certain features or components relative to a specific embodiment of the present disclosure should not be construed as limiting the application or inclusion of said features or components to the specific embodiment unless stated. As such, other embodiments can also include said features, components, members, elements, parts, and/or portions without necessarily departing from the scope of the present disclosure. The embodiments described herein are examples of the present disclosure. Accordingly, unless a feature or component is described as requiring another feature or component in combination therewith, any feature herein may be combined with any other feature of a same or different embodiment disclosed herein. Although only a few of the example embodiments have been described in detail herein, those skilled in the art will appreciate that modifications are possible without materially departing from the present disclosure described herein. Accordingly, all modifications may be included within the scope of this invention.

What is claimed is:

1. A music playlist creation system comprising:
a first software application that generates the one or more primary music playlists;
a second software application on the smart device, the second software application programmed to:
receive the one or more primary music playlists from the first software application;
provide a plurality of screens that allow the one or more primary music playlists to be searched and selected to create one or more secondary music playlists, adjustable criteria in preparing the one or more secondary music playlists; selection of events that are connected to the one of more secondary music playlists, access to each song in the one or more secondary playlists to be rated, and one or more tertiary music playlists to be generated based on the adjustable criteria and ratings.

2. The music playlist creation system of claim 1, further comprising a smart device.

3. The music playlist creation system of claim 2, wherein the smart device comprises one or more processors, memory, and storage.

4. The music playlist creation system of claim 2, wherein the smart device comprises a smart phone, tablet, or a computer.

5. The music playlist creation system of claim 1, wherein the first application comprises a music streaming platform.

6. The music playlist creation system of claim 1, wherein the plurality of screens comprises a first screen, a second screen, a third screen, a fourth screen, a fifth screen, a sixth screen, and a seventh screen.

7. The music playlist creation system of claim 1, wherein the adjustable criteria include track, artist, genre, total results, and randomized threshold.

8. The music playlist creation system of claim 6, wherein the fifth screen provides a play song button, a previous button, and a next button.

9. The music playlist creation system of claim 6, wherein the fifth screen provides rating icons to rate each song in the one or more secondary playlists.

10. The music playlist creation system of claim 9, wherein the rating icons may be like and dislike icons, percentages, or a number scale.

11. The music playlist creation system of claim 6, wherein the seventh screen includes the track, artist, and a match percentage based on the ratings received.

12. The music playlist creation system of claim 6, wherein the seventh screen allows the one or more tertiary music playlists to be exported from the second application.

13. The music playlist creation system of claim 1, wherein the first software application is accessible via the second software application.

14. A music playlist creation system comprising:
a smart device;
a first software application that generates the one or more primary music playlists;
a second software application on the smart device, the second software application programmed to:
receive the one or more primary music playlists from the first software application;
provide a first screen with a search playlist box that allows the one or more primary music playlists to be searched and selected to create one or more secondary music playlists;
provide a second screen that comprises adjustable criteria that when adjusted determine how important each of the adjustable criteria is in preparing the one or more secondary music playlists;
provide a third screen to select events that become connected to the one or more secondary music playlists;
provide a fourth screen to input personal identifying information;
provide a fifth screen that allows access to each song in the one or more secondary playlists to be rated;
provide a sixth screen that generates one or more tertiary music playlists based on the adjustable criteria in the second screen and ratings provided in the fifth screen; and
provide a seventh screen that allows the one or more tertiary music playlists to be exported from the second application.

15. The music playlist creation system of claim 14, wherein first application comprises a music streaming platform.

16. The music playlist creation system of claim 14, wherein the fifth screen provides rating icons to rate each song in the one or more secondary playlists.

17. The music playlist creation system of claim 14, wherein the seventh screen includes the track, artist, and a match percentage based on the ratings received.

18. The music playlist creation system of claim 14, wherein the first software application is accessible via the second software application.

19. The music playlist creation system of claim 14, wherein the adjustable criteria include track, artist, genre, total results, and randomized threshold.

20. A music playlist creation system comprising:
a smart device;
a first software application that generates the one or more primary music playlists;
a second software application on the smart device, the second software application programmed to:
receive the one or more primary music playlists from the first software application selected by a first user;
provide a first screen with a search playlist box that allows the one or more primary music playlists to be searched and selected by a second user to create one or more secondary music playlists;
provide a second screen that comprises adjustable criteria that when adjusted determine how important each of the adjustable criteria is in preparing the one or more secondary music playlists;
provide a third screen to select events that become connected to the one or more secondary music playlists;
provide a fourth screen to input personal identifying information by a third user;
provide a fifth screen that allows access to each song in the one or more secondary playlists to be rated by the third user, wherein the fifth screen provides a play song button, a previous button, and a next button, wherein the fifth screen provides rating icons to rate each song in the one or more secondary playlists; and
provide a sixth screen that generates one or more tertiary music playlists based on the adjustable criteria in the second screen and ratings provided in the fifth screen.
